(19) United States
(12) Patent Application Publication
(10) Pub. No.: US 2004/0236592 A1
(43) Pub. Date: Nov. 25, 2004

(54) Method for providing personalized programs to retail customers

(76) Inventors: Margaret Aleles, Gladstone, NJ (US); Steven A. Shaya, Highlands, NJ (US); Anna Marie Newton, Bethlehem, PA (US); Katie Cheng, West Orange, NJ (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/695,686

(22) Filed: Oct. 29, 2003

Related U.S. Application Data
(60) Provisional application No. 60/422,724, filed on Oct. 31, 2002.
(60) Provisional application No. 60/482,443, filed on Jun. 26, 2003.

(51) Int. Cl. G06F 17/60

(52) U.S. Cl. 705/1

(57) ABSTRACT

This invention relates to a method of providing an individualized hair care program to a customer in a retail shopping environment. More specifically, the present invention is directed to a method of providing an individualized hair care program to a customer in a retail shopping environment, which entails obtaining personal information from the customer in the retail shopping environment, using the information to create an individualized hair care program for the customer, and providing the individualized hair care program to the customer in the retail shopping environment.

### FIELD OF THE INVENTION

This invention relates generally to a method of providing an individualized hair care program to a customer in a retail shopping environment. More specifically, the invention relates to providing an individualized hair care program to a customer in a retail shopping environment by obtaining objective personal information from the customer in the retail shopping environment, using the personal information to create an individualized hair care program to the customer, and providing the individualized hair care program to the customer in the retail shopping environment.

### BACKGROUND OF THE INVENTION

Retail shopping environments are common outlets in which customers generally shop for and/or purchase consumer products, services, and other necessary items for their own use and the use of their families. Salespeople may be available in such outlets to provide assistance to the customer.

The hair care products that are provided in such outlets are generally available in a multiplicity of sizes, types, brands, colors, versions, styles, and concentrations, with a variety of performance characteristics and other properties. The customer looks at and evaluates the products with respect to his or her own needs and requirements, and attempts to select the products accordingly. In some cases, a salesperson may provide assistance or recommendations to the customer in the selection. However, the salesperson's assistance is based on limited and/or subjective knowledge of the customer's personal information and needs, and of the products that are available. Thus, the customer is ultimately responsible for making the selection. In many cases, the customer may find it difficult to determine the most appropriate hair care product for his or her requirements and may resort to the use of a trial and error approach to selection by buying a first product based on a best guess of its suitability to the customer's needs.

After the first product is used for a period of time, the customer may evaluate the product's efficacy or otherwise determine whether or not the product was indeed appropriate. If, after use, the first product is found not to be suitable, the customer may then return to the same or another retail shopping outlet and select a second product for trial. If, after use of this second product, the customer determines that the second product is not suitable either, a third product may be purchased. This trial and error process may continue until the customer either finds a product that is suitable, or, out of frustration, compromises on the use of a product that is not entirely suitable. The whole process of trial and error is time-consuming, costly, and frustrating to the customer.

Likewise, some retail outlets, such as hair care salons may also offer a variety of hair care services to customers. In such cases, also, although salespeople or hair care service providers may be available to advise or make recommendations to the-customer about the services, the salesperson's or service provider's recommendations are based upon limited or subjective knowledge of the customer and the customer's needs. Thus, the customer must ultimately evaluate and attempt to select the most appropriate service for his or her own needs. Again, the customer must often use a trial and error approach to finding the right hair care service to meet his or her needs.

In general, the retail shopping environment tends to be impersonal. The customer is left substantially alone to pick and choose the hair care products and services that are most suited to his or her own needs and preferences. This can be a daunting task to most customers because of the vast range of products and services available in-different outlets from which to select, even within a single category, such as hair care. Even when a salesperson or service provider is available to assist the customer with or make recommendations for product or service selections, the salesperson's or provider's assistance and recommendations are based upon a limited and/or subjective knowledge of the customer and the customer's hair care needs.

Often, too, the customer's hair care needs may include a need for education, such as, for example, hair care during specific life stages (i.e., menopause or pregnancy), hair styling methods, hair loss, chemical or treatment damage, or effects of stress on hair. The customer may also have a particular hair condition that should be evaluated by a dermatologist, although the customer is unaware of this fact. Alternatively, the customer may be unsure whether a particular hair condition is normal or should be evaluated by a doctor.

A need exists for a method of providing customers in a retail shopping environment with an individualized hair care program based on the customer's own personal information.

### SUMMARY OF THE INVENTION

The present invention relates to a method of providing an individualized hair care program to a customer in a retail shopping environment. More specifically, the present invention is directed to a method of providing an individualized hair care program to a customer in a retail shopping environment, which entails obtaining personal information from the customer in the retail shopping environment, using the information to create an individualized hair care program for the customer, and providing the individualized hair care program to the customer in the retail shopping environment. The personal information obtained from the customer includes objective information. The individualized hair care program has at least two of the following elements: a recommendation for at least one hair care product, a recommendation for at least one hair care activity, and a recommendation for at least one hair care service.

In another embodiment, the present invention relates to a method of providing an individualized hair care program to a customer in a retail shopping environment, which entails obtaining personal information, including objective information, from the customer in the retail shopping environment, and using the personal information to generate individualized hair care needs for the customer. An individualized hair care needs assessment is created by evaluating the individualized hair care needs against standards that reflect needs for at least two of the following: needs for hair care services, needs for hair care activities, and needs for hair care products. The individualized hair care needs assessment is used to create an individualized hair care program, which has at least one of the following: a hair care product, a hair care service, or a hair care activity. The individualized hair care program is then provided to the customer.

In another embodiment, the present invention relates to a method of providing a personalized hair care program to a customer, which involves obtaining personal information from the customer in a first retail location, using the information to create a personalized hair care program for the customer, and providing the personalized hair care program to the customer. The personalized hair care program has at least two of the following elements: a recommendation for at least one hair care product, a recommendation for at least one hair care activity, and a recommendation for at least one hair care service.

In this embodiment, the first retail location is one of a plurality of retail locations that are in data communication with one another. Preferably, all the retail locations are in data communication with one another. Thus, the data relating to the personal information and the personalized hair care program may be communicated from the first retail location to any one of the plurality of retail locations that are in data communication with one another. Likewise, the data relating to the personal information and the personalized hair care program may be retrieved from any one of the plurality of retail locations that are in data communication with one another. The data may be updated or changed at the first or a second retail location and may be retrieved from any one of the plurality of retail locations that are in data communication with one another.

### BRIEF DESCRIPTION OF THE DRAWINGS

FIG. 1 is a flow diagram of the process of an embodiment of the present invention.

FIG. 2 shows a logical flow diagram of the process for obtaining personal information of an embodiment of the present invention.

FIG. 3 shows a logical flow diagram of the process for objective hair evaluation of an embodiment of the present invention.

FIG. 4 shows a flow diagram of the process for creating a personalized hair care program of the present invention.

FIG. 5 shows an embodiment of an individualized hair care program.

### DETAILED DESCRIPTION OF THE INVENTION

According to the present invention, methods are described for providing customers with individualized hair care programs in retail shopping environments. Specifically, in one embodiment, the method of this invention relates to a method of providing a customer with a personalized hair care program in a retail shopping environment, including, in a retail shopping environment,

a) obtaining personal information from a customer, the personal information comprising objective information;

b) using the personal information to create a personalized hair care program for the customer; and

c) providing the personalized hair care program to the customer, wherein the personalized hair care program has at least two elements selected from the following: a recommendation for at least one hair care product, a recommendation for at least one hair care service, and a recommendation for at least one hair care activity.

As used herein, “retail shopping environment” includes business establishments stocked with items for sale or with standard services for sale, where consumers go to examine goods and services with the possible intent to buy for their personal or household use. Examples of such retail shopping environments include, without limitation, department stores, shopping malls, shopping centers, kiosks, drug stores, mass merchandisers, specialty shops, grocery stores, hair care salons, and convenience stores. Typically, consumers may come and go freely during the normal operating business hours of these retail shopping environments. In other words, customers do not need to make appointments to visit such retail shopping environments.

The personal information that is obtained from the customer includes objective information and preferably also includes subjective information. Objective information is obtained by measuring certain properties of the hair or scalp, such as, for example, by taking physical or biological or other objective measurements. For example, hair strength may be measured by removing a hair from a customer and measuring the force required to break the hair if it is pulled in the axial direction. Likewise, one modulus of the hair may be measured by pulling the hair in the axial direction and measuring the extension of the hair's length in relation to the force that is applied in stretching it to that length, then correcting this number for the area of the hair shaft. Instruments that are suitable for measuring such tensile properties of hair include, without limitation, Miniature. Tensile Testers made by Dia-Stron Limited and available from cyberDERM Inc. of Media, Pa.

Further nonlimiting examples of objective information relating to the hair may include average measurements or distribution in the measurements of hair diameter, and measurements of hair porosity, hair damage, hair fullness, hair color, hair shaft cross-sectional shape, scalp oiliness, dandruff gradient, scalp skin moisture, and terminal hair density (or thinning).

Subjective information may be obtained from the customer by questioning means, that is, by the customer's answering questions, which are asked of him or her, either orally or in written form, or electronically, such as via a computer terminal or other electronic device. The questioning means may be an interviewer asking oral questions of the customer, a written questionnaire on which the customer writes answers to the written questions, or an electronic questionnaire viewed by the customer on a computer screen or other electronic video device and for which the customer submits answers to the questions by typing on a keyboard, touching a responsive screen, speaking an answer, or the like. The questions may be binary, categorical, or scalar.

Subjective information may include, without limitation, age, natural hair color, use of chemical hair treatments such as hair colors or permanents, frequency of chemical hair treatments, eye color, height, weight, gender, ethnic background, self-described lifestyle information, hair care habits, hair care product use preferences, personal hair history, exercise habits, cosmetic and fashion color preferences, skin and scalp sensitivity, skin problems and concerns, hair care questions, dietary habits, allergies, stress levels, sleep habits, allergies, hair oiliness, prescription and nonprescription drug use, scalp flakiness, scalp itchiness, use of hair styling utensils and implements, and menstrual cycle information for females. Lifestyle information may include such information as occupational environmental conditions (i.e., dusty, warm, cool, dry, humid), average exposure to sun and wind and outdoor environmental conditions, and frequency and type of exercise.

After the personal information is collected from the customer, it is used to create an individualized hair care program for the customer. The information may be used to generate scores according to predetermined rules, formulae or algorithms, and these scores used in the selection of the elements of the individualized hair care program.

The personal information may be used to generate individualized hair care needs for the customer. These individualized hair care needs are then evaluated against standards that reflect needs for at least two of the following: needs for hair care products, needs for hair care services, and needs for hair care activities. This evaluation is then used to create an individualized hair care needs assessment. The individualized hair care needs assessment is used to create the individualized hair care program for the customer. The individualized hair care program has at least one of the following: a hair care service, a hair care product, or a hair care activity. The individualized hair care program is then provided to the customer, preferably in the retail environment. Alternatively, the hair care program may be in a written form, which may be provided to the customer through the mail or electronically, such as by electronic mail.

The elements of the individualized hair care program preferably include at least two of the following: a recommendation for at least one hair care product, a recommendation for at least one hair care service, and a recommendation for at least one hair care activity.

Exemplary hair care products may include, without limitation, shampoos; conditioners; hair care implements is such as brushes, combs, nets and styling devices; styling aids such as gels, mousses or spritzes; hair sprays; hair straightening products; hair accessories such as barrettes or headbands; hair powder; hair mascara; hair extensions or hair pieces; depilatories; hair removal waxes; essential oils; scalp/hair treatment oils; hair growth products; oral supplements; hair texturizers; hair sunblock; hair towels; hair loss prevention products including but not limited to those designed for use during chemotherapy and those designed to prevent general undesired hair loss. Further exemplary hair care products may also include, without limitation, scalp care products, such as dandruff treatments, eczema treatments, dry skin lotions, sunscreen lotions, anti-itch preparations, toners, or anti-infective treatments. Hair care services may include, without limitation, washing with appropriate shampoos and conditioners; styling with appropriate styling methods and products; permanent waving; hair straightening; hair coloring; hair cutting (in particular, coordination of optimal hair color and cut with skin and eye color and face morphology); scalp, head and neck massage; deep conditioning; baldness treatments; hair weaving; hair follicle induction or transplantation ; shaving; hair removal, such as by waxing, depilation, electrolysis, or laser treatment; personalized color analysis; personalized hair style analysis; scalp treatments; hair growth treatments; email or postcard reminders for hair cut or coloring; special occasion hair styling; and the like.

Nonlimiting examples of hair care activities include seminars on such subjects as stress and stress reduction, hair styling, seasonal hair needs, ethnic hair care, hair loss, hair care during pregnancy, hair care during menopause, hair care for women, hair care for men, and general hair care; support groups for people with hair loss or other hair-related conditions; physician referrals and appointments; dermatologist visits; stress reduction programs; and videotaped or internet-based informational programs to which the customer is given access.

Once the elements of an individualized hair care program have been identified, the program is preferably provided to the customer in the retail shopping environment. The program is preferably provided to the customer through one or more hair care counseling sessions. Alternatively, the program may be provided to the customer through a written report. Preferably, the program is provided to the customer through one or more counseling sessions, at which time, the customer also receives a written report of the hair care program.

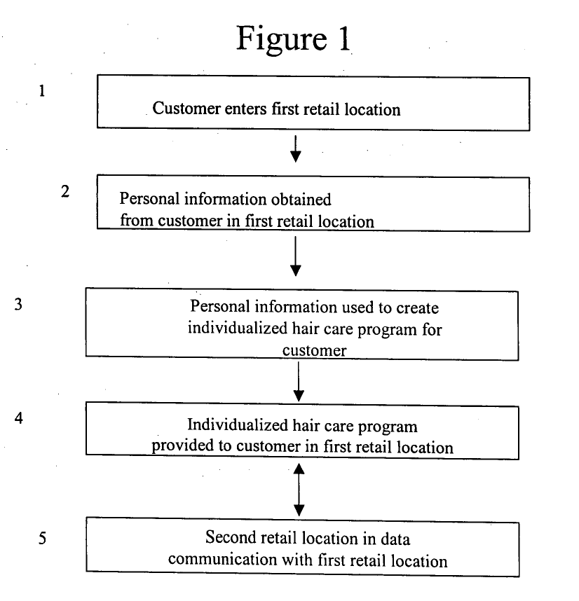

Referring now to FIG. 1, in a first part 1, a customer enters a first retail location. In part 2, the customer provides personal information in the first retail location. The personal information comprises objective personal information and may also include subjective personal information. Preferably, the personal information comprises a combination of subjective and objective personal information. The personal information is then used to create an individualized hair care program for the customer in part 3, and the individualized hair care program is provided to the customer in part 4. The hair care program has at least two of the following: a recommendation for at least one, hair care product, a recommendation for at least one hair care activity, and a recommendation for at least one hair care service. The hair care program may be provided to the customer by a counseling session with a professional hair care consultant or by a written report, or preferably, by both a counseling session with a professional hair care consultant and a written report. As shown in part 5, the first retail location is in data communication with a second retail location. Thus, the customer may later visit the second retail location and retrieve his or her personal information and individualized hair care program from the first location.

As used herein, “retail location” refers to a particular business establishment in one place stocked with items for sale where consumers go to examine goods and services with the possible intent to buy for their personal or household use. Examples of such retail locations include, without limitation, department stores, shopping malls, shopping centers, kiosks, drug stores, mass merchandisers, specialty shops, grocery stores, and convenience stores. Typically, consumers may come and go freely during the normal business operating hours of a retail location. In other words, customers do not need to make appointments to visit such retail locations.

The first retail location is one of a plurality of retail locations that are in data communication with one another. As used herein, “data communication” means that data such as personal customer information and personalized skin care program information may be transmitted or exchanged from a first retail location to a second retail location, or retrieved from the first retail location by a second retail location. The data communication preferably occurs by way of a network environment. Network environments may be arranged in a variety of configurations, and the invention is in no way intended to be limited to the examples and embodiments described herein. An example of a network environment is a client-server system, which includes client computers, which may be personal computers, hand-held computing devices, and the like. The client-server system also includes at least one server computer, which is coupled to and controls a storage element.

The client and server computers communicate with one another by way of a communications network, which may comprise any number of networking technologies such as a LAN, a WAN, an intranet, the Internet, and the like. In such a client-server system, the data comprising the personal customer information and the personalized hair care programs is stored electronically in a database residing on the storage element. Each of the plurality of retail locations has a client computer which may access the data via the network linking the client-server system. Additionally, the client computers may communicate with one another via the network.

In an alternative embodiment, a client computer may transmit data to another client computer that is in a location other than one of the plurality of retail locations. For example, the data may optionally be transmitted to a client computer in a dermatologist's or other professional's office, such as might be helpful if the customer were visiting a dermatologist as a result of receiving a recommendation to see a dermatologist as part of her personalized hair care program. In such a case, the dermatologist might find it useful to see the personal information that was obtained in the first retail location.

A customer may visit a first retail location and obtain a personalized hair care program at that location. The personal information and the personalized hair care program are retained by the first retail location with a personal identifier unique to the customer. Later, the customer may visit a second such retail location in data communication with the first. The second retail location may access her personal information and her personalized hair care program via the personal identifier, and allow the customer to access and view the information and the program. A professional hair care consultant at the second retail location also may access and view the customer's personalized hair care program with the customer's permission, so that the consultant can provide advice to the customer with regard to the personalized hair care program.

In another embodiment of the invention, primary personal information is obtained from a customer, and the customer is provided with an initial personalized hair care program in a first retail location in the same manner as in preceding embodiments. The primary personal information and the initial personalized hair care program are retained by the first retail location with a personal identifier unique to the customer. After a time, the customer returns to the first or to a second retail location in data communication with the first, and secondary personal information is obtained from the customer. The primary personal information and the initial personalized hair care program are retrieved according to the customer's unique personal identifier. The secondary personal information may then be compared to the primary personal information and is used to create a secondary personal hair care program, which is then provided to the customer. The secondary personal hair care program has at least two elements selected from the following: a recommendation for at least one hair care product, a recommendation for at least one hair care activity, and a recommendation for at least one hair care service. The secondary personal hair care program may be similar to the initial hair care program if the customer's secondary personal information is similar to the customer's primary personal information. Alternatively, the secondary personal hair care program may have one or more elements that differ from the elements of the primary personal hair care program.

However, if the customer's secondary personal information is different from the customer's primary personal information, the secondary hair care program may be different from the initial hair care program. Thus, if the customer follows the recommendations of the initial hair care program, her hair condition may change, and she may need a different type of hair care product or service or activity. Thus, the secondary personal information would reflect this hair condition change, and the secondary hair care program would also reflect the different needs related thereto.

Over time, as the customer continues to visit the retail locations and receive updated personalized hair care programs, a history of her hair condition and its response to the products, services, and activities of her personalized hair care programs is established. This historical information may then be used to develop, refine, or support standards used in creating the recommendations of future products, services, and activities for this and other customers. In a further embodiment of the invention, the personal information includes objective measurements of-the customer's hair.

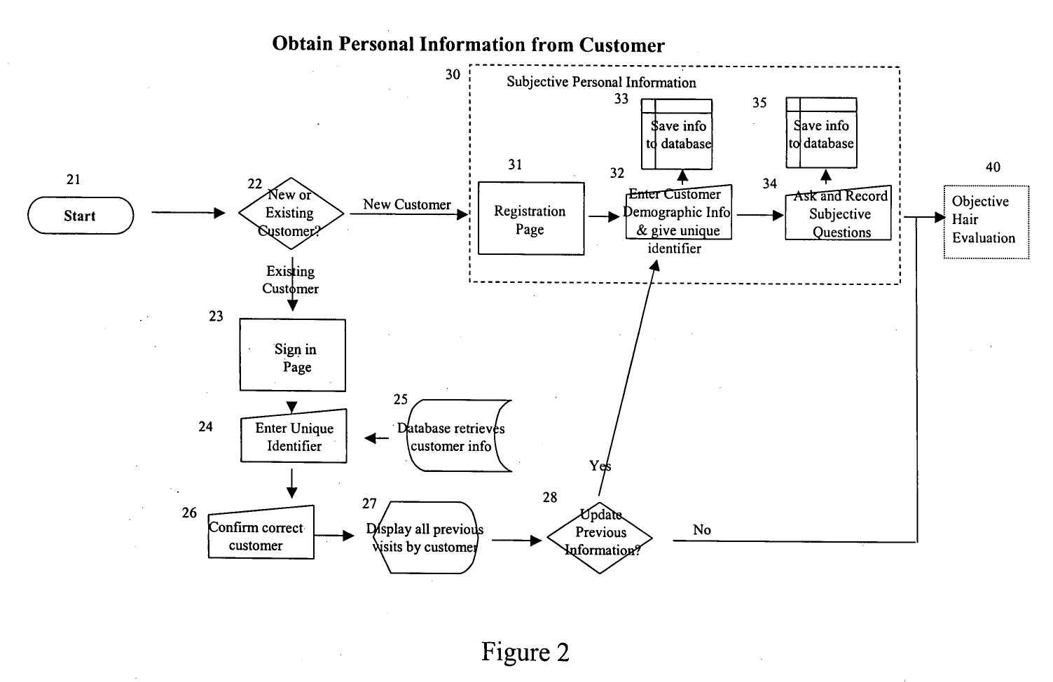

Referring now to FIG. 2, a customer enters a retail outlet 21 and a determination is made as to whether the customer is a new or an existing customer 22.

If the customer is returning as an existing customer, she signs in at a sign-in page 23 using her unique identifier 24, or user name and ID. A database then retrieves the customer information 25 associated with her unique identifier. A confirmation step 26 ascertains that the unique identifier is the correct one for the customer, and records of her previous visits are displayed 27. The records of her previous visits may include her personal customer information, her previously acquired objective hair measurements, her previous answers to self-perception questions, and any other information about the customer that may have been stored in the database, including her personalized hair care program(s). If the customer wishes to add or change information that is different from her information from previous visits 28, she may then proceed to update her information with objective hair measurements, new personal information, or new answers to the same or different self-perception questions, as in the Subjective Personal Information step 30.

If the customer is new, she is asked to complete a registration page 31, on which she enters her customer demographic information. She is given a unique identifier 32. This customer demographic information is saved in a secure database 33 with the unique identifier. Subjective questions are then asked of the customer 34 and her answers to these questions are also saved in a secure database 35 along with the unique identifier.

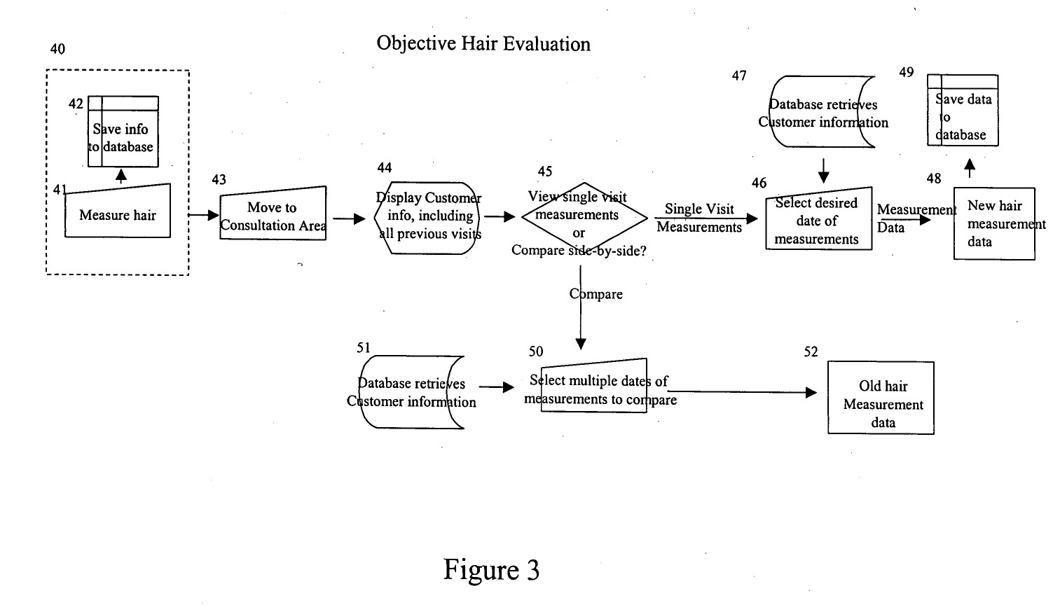

As shown in FIG. 3, quantitative measurements of the customer's are then made 41 and stored in the same or a different database 42 with the unique identifier. The customer is then asked to meet with a consultant and review her information in a consultation area 43, at which time the customer's personal information is displayed, including any personal information from previous visits 44. The customer selects whether to view only the measurements made on a single visit or a side-by-side comparison of the measurements made on two different visits 45. If this is the customer's first visit, there are only measurements made on a single visit to view; however, if the customer had previous visits, she may choose whether or not to view a comparison of measurements made on multiple visits 50, in which case, customer information including earlier measurements is retrieved from a database 51.

If this is the customer's first visit, or if the customer chooses to view only the measurements from one visit, the customer selects the date of the measurements 46 that she wishes to view. The measurements and related customer information are retrieved from a database 47 where they are stored.

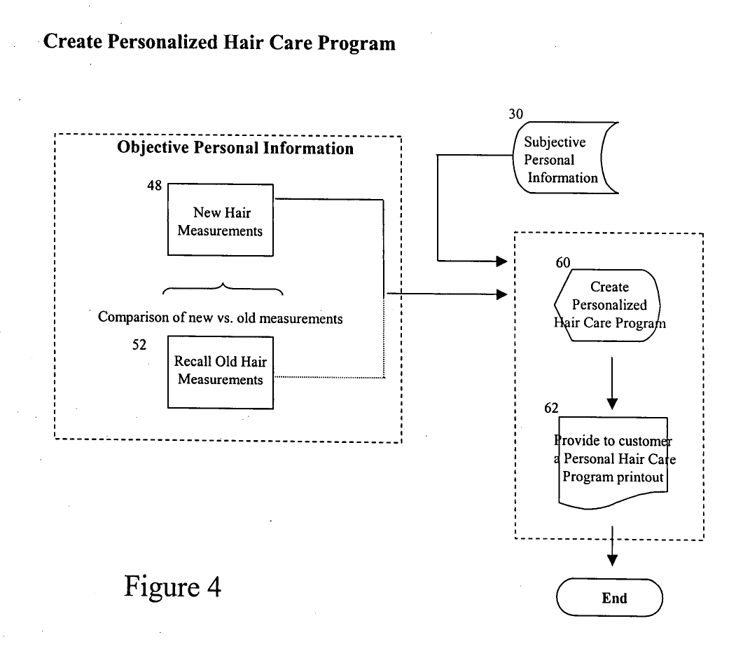

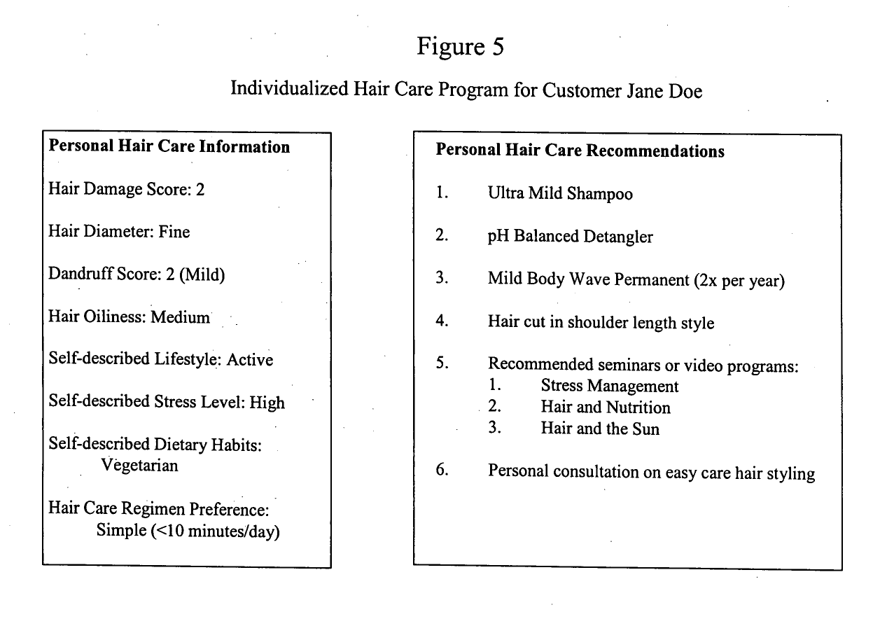

As shown in FIG. 4, the objective personal information comprising the new hair measurements 48 and, optionally, old hair measurements 52, are combined with subjective personal information 30 to create a personalized hair care program 60. This personalized hair care program is then provided to the customer 62 in the form of a personalized hair care program print-out, or written report. An example of a personalized hair care program is illustrated in FIG. 5. Preferably, the personalized hair care program is also provided to the customer through a counseling session with a professional hair care consultant.

An example of a method of using the customer's personal information to create a personalized hair care report involves first assigning scores to a customer's hair care needs. These scores are based upon objective information, such as her quantitative hair measurements. Other scores may also be assigned to the customer's subjective information, such as, for example, customer age scores, customer lifestyle scores, customer product preference scores, and the like. These scores that are assigned to the customer's subjective information are based upon a standardized scale that assigns a score to each potential answer a customer may provide to each subjective question. The scores may be based on a range, such as from 1-5, or on a binary system, such as “yes” or “no”. The hair care consultants are preferably trained in the use of the scale so that it is applied consistently by all consultants to all customers in all retail locations. These personal information scores serve to quantify the customer's hair care needs.

Likewise, each of the possible products, activities, and services that may be offered to a customer are matched with the appropriate scores or ranges of scores for the appropriate hair care needs. These matches represent standards that reflect the hair care needs associated with the personal information scores. For example, a moisturizing conditioner is matched to a range of hair damage scores that indicate the customer has dry hair.

This same conditioner is not matched to the range of hair damage and dryness scores that indicate the customer has very oily hair with little damage. In this case, light conditioning product is matched to hair damage and dryness scores that indicate oily hair.

In some cases, the customer's hair care needs will include scores that indicate she should use a certain product for one condition, although that product may not be appropriate for another condition. In such cases, the scores associated with certain conditions will be given greater weight than others. Generally, the scores associated with conditions about which the customer has greater concerns will be given the most weight in evaluating for the appropriate products, services, and activities.

This evaluation of the customer's personal hair care needs against the standards that reflect needs for certain products, activities, and services, results in the customer's individualized hair care needs assessment. This needs assessment is used to create the customer's personalized hair care program.

### EXAMPLE 1

### Method of Providing a Personalized Hair Care Program

In one embodiment of the present invention, a customer enters the retail location and identifies herself as a new customer. She is greeted by a professional hair care consultant, who asks her to provide some personal information by completing a registration page and further questionnaire. The customer is invited to sit at a computer terminal where she views and completes the registration page and answers the questions of the questionnaire. Completion of the registration page involves providing first and last names, address, mother's maiden name (for security purposes and identification confirmation), phone number, email address, gender, age bracket. The questionnaire involves further questions about how the customer found out about the retail location, where she/he usually shops for hair care products, brands of hair care products most frequently used, existing or planned pregnancy, dermatologist visits within the past year, prescription hair care product usage, history of laser hair removal. She then receives a unique personal identifier, which is her membership number. The personal information is saved to a database with the unique personal identifier. She then answers self-perception questions, which she may answer by selecting one of multiple possible answers. Nonlimiting examples of self-perception questions include questions about lifestyle information, hair care product use preferences, personal hair care history, personal hair color preferences, natural hair fineness or coarseness, natural hair waviness or straightness, history of chemical hair treatments, exercise schedule, cosmetic and fashion color preferences, hair problems and concerns, hair care questions, dietary habits, allergies, stress levels, sleep habits, how prone to acne or break-outs her skin is, and how concerned she is about facial hair. The personal information comprising her answers to these self-perception questions is also saved to a database in conjunction with her unique personal identifier.

The customer's hair is then tested to obtain objective measurements on such properties as hair damage, hair diameter, hair strength, hair porosity, hair fullness, hair diameter, hair thinning, scalp skin moisture, scalp oiliness, and dandruff gradient.

The measurements from each test are used with the subjective personal information to select the appropriate product recommendation, service recommendation, and/or activity recommendation of the personalized hair care program for the customer based on her individual needs and conditions.

Additionally, the professional hair care consultant may also evaluate the customer's hair to provide a professional evaluation, which may be also be used with the test measurements and subjective information to select the appropriate product, service, and/or activity recommendations of the personalized hair care program for the customer.

The personalized hair care program is then provided to the customer in a counseling session where the professional hair care consultant sits with the customer in a consultation area or counseling area, which is a private or semi-private portion of the retail location. The consultant may show the measurements to the customer in this counseling session so that the customer may see certain features of her hair, such as, for example, the porosity of her hair. As the consultant provides the details of the personalized hair care program to the customer, the consultant may also provide the customer with brochures or other educational information for her own individualized needs, or with schedules and pricing of available activities or services recommended in the customer's program. The activities or services may be provided in the retail location or they may be provided at an alternate location. The products recommended to the customer as part of her personalized hair care program are available for her purchase in the retail location.

Test Methods

Hair Damage

Hair damage at any section of a hair may be defined as the lifting and breaking of cuticle scale on a hair shaft. Defining this parameter as a function of distance from the scalp reveals both level of damage and rate of damage. A single hair is held adjacent to a graduated scale and examined under a microscope or other magnifying means. The hair is assigned a grade of from 1 to 5 at each centimeter of its length starting at the root end (the end closest to the scalp) and ending at the distal end (the end furthest from the scalp). The grading scale that is used is defined as follows:

1—scales flat against surface of hair shaft

2—scales slightly raised (<about 20° from surface of hair shaft) and little sign of breaking.

3—scales moderately raised (between about 20° and 45° from surface of hair shaft) with light indications of breaking.

4—scales severely raised (between about 45° and 90° from surface of hair shaft) and evident breaking.

5—scales gone. No cuticle on hair shaft.

Alternatively, the lifting of the scales and the breaking may be assessed separately and each given a score according to the grading scale above.

Generally, the scores are lower near the root end of the hair and increase toward the distal end of the hair. This data is used to assess the customer's hair condition with respect to the amount of damage present and the sensitivity of the hair to breakage in the context of the customer's hair care habits and practices. The slope of a plot of the hair damage score plotted against the distance from the scalp end of the hair provides information about hair damage sensitivity.

Hair Porosity

Hair porosity is a measure of the hair's ability to absorb water or other chemicals. One method of measuring hair porosity is by measuring the rate of weight change when hairs are dried and then placed in a fixed humidity atmosphere. An alternate method of measuring porosity involves first soaking a hair in a solution of a metal salt for a short, specified time and then using ion selective imaging electron microscopy to measure the depth of penetration of the metal within the hair.

Hair Diameter

The diameter of a single hair may be measured at predetermined distances from the root end using any known method of determining the small diameters, such as optical calipers, projection microscopy, or electron microscopy. This test may be conducted on multiple hairs from different locations on the head, such as the side, back, and top. Differences-in hair diameter between the top and sides of the head may be used to indicate a predisposition to male pattern baldness.

Hair Yield Strength

Multiple hairs are removed from a customer. Each hair is subjected to an axial force until it breaks. The average force required to cause the break is the yield strength of the hair. The individual hair diameters are often used as a covariate.

Hair Modulus

Multiple hairs are obtained from a customer. The hairs are subjected to an axial force and the extension of the hair is recorded as a function of the applied force. The ratio of force to extension divided by the cross-sectional area of the hair shaft is a measure of the modulus of the hair. An average of the multiple hair values is reported as the hair modulus.

Scalp Skin Moisture

The moisture of a customer's scalp skin is measured by capacitance in the same manner as skin moisture is measured by capacitance. [add general description of this] An instrument that may be used for the purpose is the CORNEOMETER CM820, available from Courage and Khazaka Electronic GmbH, Koln, Germany. The scalp skin moisture measurements are conducted in a room or area with a controlled atmosphere having constant temperature and relative humidity. In instances where the customer's hair is particularly thick, special probe electrodes shaped like tines may be used.

Scalp Oiliness

A preweighed dry swab is moistened with isopropanol and wiped over a predetermined area of the scalp. The swab is then dried to evaporate the isopropanol, and weighed again. The difference in the weights is the amount of oil from the portion of the scalp that was wiped and is an indicator of the oiliness of the scalp.

Dandruff Grades

Dandruff may be graded by a trained professional using a scale as indicated in Table I. Preferably, several locations on the customer's scalp are examined and graded by the trained professional. The grades may be added together to give a total dandruff grade.

TABLE I

| Dandruff Score | Scalp condition |
|---|---|
| 0 | No scaling |
| 1-2 | Mild; small flakes resembling a |
| | coarse grayish/white powder |
| 3-4 | Moderate; small to medium size |
| | thin flakes |
| 5-6 | Marked; large thin flakes loosely |
| | attached to the scalp |
| 7-8 | Severe; large adherent flakes |
| 9-10 | Heavy; flakes adhering to the |
| | scalp as thick white or yellow |
| | squames |

Combing Resistance

Combing resistance may be used to evaluate the surface of the hair. The Miniature Tensile Tester MTT170 made by Dia-Stron Ltd. is suitable for this purpose.

The specification and embodiments above are presented to aid in the complete and non-limiting understanding of the invention disclosed herein. Since many variations and embodiments of the invention can be made without departing from its spirit and scope, the invention resides in the claims hereinafter appended.

We claim:

1. A method of providing an individualized hair care program to a customer, the method comprising, in a first retail location:
a) obtaining personal information from a customer;
b) using the personal information to create an individualized hair care program for the customer;
c) providing the individualized hair care program to the customer, wherein the individualized hair care program comprises at least two elements selected from the group consisting of a recommendation for at least one hair care product, a recommendation for at least one hair care activity, and a recommendation for at least one hair care service;
d) wherein the first retail location is one of a plurality of retail locations in data communication with one another.

2. The method of claim 1 wherein data comprising the personal information is communicated from the first retail location to a second retail location.

3. The method of claim 1 wherein data comprising the individualized hair care program is communicated from the first retail location to a second retail location.

4. The method of claim 1 wherein-data comprising the personal information and the individualized hair care program are communicated from the first retail location to a second retail location.

5. The method of claim 4 wherein the data comprising the personal information and the individualized hair care program are communicated from the first retail location to the second retail location at the customer's direction

6. A method of providing an individualized hair care program to a customer in a retail shopping environment, the method comprising, in a retail shopping environment:
a) obtaining personal information comprising objective information from a customer;
b) using the personal information to generate individualized hair care needs for the customer;
c) evaluating the individualized hair care needs against standards that reflect needs for hair care products, needs for hair care services, and needs for hair care activities, to create an individualized hair care needs assessment;
d) using the individualized hair care needs assessment to create an individualized hair care program, the individualized hair care program comprising at least one element selected from the group consisting of a hair care product, a hair care service, and a hair care activity; and
e) providing the individualized hair care program to the customer.

7. A method of providing a personalized hair care program to a customer in a retail shopping environment, the method comprising:
a) obtaining personal information comprising objective information from a customer;
b) using the personal information to create a personalized hair care program for the customer;
c) providing the personalized hair care program to the customer, wherein the personalized hair care program comprises at least two elements selected from the group consisting of a recommendation for at least one hair care product, a recommendation for at least one hair care activity, and a recommendation for at least one hair care service.

8. The method of claim 7 wherein the personal information is retained with a personal identifier unique to the customer.

9. The method of claim 7 wherein the personal information comprises subjective information.

10. The method of claim 9 wherein the subjective personal information is obtained from the customer by questioning means.

11. The method of claim 10 wherein the questioning means is a personal interview.

12. The method of claim 10 wherein the questioning means is a written questionnaire.

13. The method of claim of claim 7 wherein the hair care activity is an educational seminar.

14. The method of claim 7 wherein the hair care activity is a recommendation for the customer to be examined by a dermatologist.

15. A method of providing a personalized hair care program to a customer in a retail shopping environment, the method comprising
a) obtaining personal information from a customer;
b) objectively evaluating a portion of the customer's hair to create a hair measurement;
c) analyzing the hair measurement to create a hair analysis report;
d) providing a professional evaluation of the customer's hair by a professional hair care consultant;
e) using the personal information, the professional evaluation, and the hair analysis report to create a personalized hair care program for the customer; and
f) providing the personalized hair care program to the customer, wherein the hair care program comprises recommendations for at least one hair care product, at least one hair care activity, and at least one hair care service.

16. The method of claim 15 wherein the personalized hair care program is provided to the customer through one or more hair care counseling sessions with a professional hair care consultant.

17. The method of claim 15 wherein the personalized hair care program is provided to the customer through a written report.

18. The method of claim 15 wherein the at least one hair care activity is selected from the group consisting of educational seminars, an appointment with a doctor, a stress reduction program, and support groups.

19. The method of claim 15 wherein the at least one hair care product is selected from the group consisting of shampoos, conditioners, styling aids, hair sprays, hair straightening products, hair mascara, hair extensions, hair pieces, depilatories, hair removal waxes, essential oils, scalp/hair treatment oils, hair growth products, oral supplements, hair texturizers, hair sunblock, hair towels, and hair loss prevention products.

20. The method of claim 15 wherein the at least one hair care service is selected from the group consisting of washing, styling, permanent waving; hair straightening; hair coloring; hair cutting; scalp, head and neck massage; deep conditioning; baldness treatments; hair follicle induction or transplantation; hair weaving; hair transplants;
shaving; laser hair removal; hair waxing;
personalized hair color analysis; personalized hair style analysis; scalp treatments; hair growth treatments; email or postcard reminders for hair services; and special occasion hair styling.

21. The method of claim 15 wherein the personal information includes subjective information.

22. The method of claim 15 wherein the personalized hair care program comprises a recommendation for the customer to be examined by a physician.

23. The method of claim 15 wherein at least one of the personal information, the hair measurement, the assessment, and the hair analysis report is retained with a personal identifier unique to the customer.

24. The method of claim 23 wherein the portion of the customer's hair is evaluated to create a first hair measurement at a first time, and a portion of the customer's hair is measured to create a second hair measurement at a second time which is later than the first time.

25. The method of claim 24 wherein the personalized hair care program further comprises a comparison of the first hair measurement and the second hair measurement.

26. The method of claim 25 wherein the personal identifier is used to retrieve the first hair measurement.
